(19) United States
(12) Patent Application Publication
(10) Pub. No.: US 2006/0033233 A1
(43) Pub. Date: Feb. 16, 2006

(54) Method for making leg model and orthopedic brace

(76) Inventor: Ian Engelman, Scarborough, ME (US)

Correspondence Address: SALTAMAR INNOVATIONS, 30 FERN LANE, SOUTH PORTLAND, ME, 04106, US

(21) Appl. No.: 10/917,210

(22) Filed: Aug. 12, 2004

(51) Int. Cl. B29C 33/40

(52) U.S. Cl. 264/223

(57) ABSTRACT

A method for making a model or a partial model of a leg is based on taking measurements of the plantar area of the foot utilizing a crushable impression block such as a crush box to create a three dimensional impression, and using the impression to cast a leg model from which a brace may be made.

### FIELD OF INVENTION

The invention relates in general to orthopedic braces, and more particularly to a method of making a leg model and a brace (orthosis) utilizing the model.

### BACKGROUND

Braces are used extensively in the orthopedic arts to provide added support to limbs requiring such support as a result of a variety of medical conditions. These specifications will use one such brace as a generalized example for a brace commonly known as an Ankle Foot Orthosis (hereinafter an AFO). It will be clear to those skilled in the art that in light of these specifications and the accompanying drawings, the application of the invention may be extended to leg braces other than an AFO, and the specifications and claims should be so interpreted.

An AFO is a medical device that assists patients who have lost at least partial control over the angle in which they can maintain their foot respective to their leg. For example, as a result of a stroke or some other medical conditions, the patient's foot cannot be raised to avoid obstacles. This may be dangerous, since the patient can trip. The AFO thus holds the foot at a predetermined angle, usually about 90 degrees, to the leg. AFO's may also be used to treat other conditions where control of a patient's foot is required. Common AFO's hold the patient's calf, ankle and foot.

Presently the process of manufacturing an AFO involves creating a cast over the patient's foot, extending above the ankle towards the patient's calf. The cast is allowed to set, and then is carefully cut. The cut cast is later used to create a ‘positive mold’, i.e. a mold representing the patient's foot, upon which the AFO is made. This process is lengthy, laborious, and is inconvenient to the patient and to the doctor.

Foam crush boxes are used for taking measurements of complex shapes, including the shape of feet, as described in U.S. Pat. No. 6,430,831 to Sundman. The crush box comprises permanently or semi permanently deformable material. For simplicity the deformable material will be referred to as an ‘impression block’. Foam based crush boxes (commonly known as impression foam) are readily available in the marketplace and will be used herein by way of example. However the term ‘impression block’ should not be construed as limited only to foam, as any material which is deformable and maintains the deformity permanently or semi permanently, (i.e. at least for sufficient length of time so as to allow creation of a positive mold, and/or model of the impressed item) may be used.

When an object such as a foot is pressed into the impression block, the deformable material block receives and maintains an impression of the body part. Measurements of the foot geometry may be obtained from the impression left in the impression block. As described by Sundman, the use of crush boxes is known in the art to create three dimensional images of the plantar surface of a foot, to create an orthotic inlay. Similar foot geometry measurement methods are further described by Tadin in U.S. Pat. Nos. 6,493,958, and 6,625,897.

### BRIEF DESCRIPTION

An object of the invention is to eliminate the necessity for the laborious process of making a cast on the patient lower leg and/or foot and making a positive model for the construction of an AFO. (For simplicity, the model will related to as a leg model, however it is to be understood that the reference to a leg should be construed as relating to the whole leg, the foot portion, or a portion of a leg or foot as will be the common meaning of such term in the context in which it is used).

Therefore there is provided a process for making at least a partial model of a leg, the process comprising the steps of forming a three dimensional impression of a plantar surface of a foot in a deformable impression block, coupling an upper portion negative mold with the impression, and casting a leg model utilizing the impression and upper mold negative. This will create a positive model for the fabrication of an AFO. Optionally, a mandrel may be coupled to the casting, preferably during the casting process, or in temporal proximity to the casting process, while the cast material has yet to complete its hardening or setting process. Preferably this embodiment further comprises the step of fairing the casting, i.e. modifying the positive mold to better fit the brace to the patients' needs. It should be noted that the term ‘casting’ also encompasses the step commonly known as ‘pouring the positive mold’ as known in the industry.

More preferably, the impression block comprise deformable foam. Furthermore, the upper portion preferably comprises a cavity approximately conformant to a person's upper foot portion.

Also preferably a photograph of the patients' leg or a portion thereof is taken to assist in measurements, but standard measurements may be taken with or without photography. Further preferably, the upper portion comprises a rearward protrusion, if needed, for some specifically desirable types of braces.

In another preferred embodiment of the invention there is provided a process for making at least a partial model of a leg, the process comprising the steps of forming a three dimensional impression of a plantar surface of a foot in a deformable impression block, casting a lower portion positive utilizing the impression, and coupling a prefabricated upper portion positive to the lower portion positive to provide at least a partial leg model. The step of coupling is preferably performed by gluing or adhering the upper and lower portions, but many other convenient method may be applied such as, by way of example, screwing, fastening, coupling using a plug and socket arrangement, mutual coupling, intermediate layer coupling, interference coupling, tying the upper and lower together or draping flexible sheet material such as a net, cloth or plastic sheet about the upper and lower part or portions thereof, or any combination of those methods. Similar improvements may be applied to this embodiment as were described above, such as applying a mandrel, fairing, and the like.

Optionally the upper portion further has at least one cavity, to allow casting material to flow into said cavity to provide improved adherence of the casting material to the upper portion, or to form the coupling. Further optionally, the upper portion may have a conduit therein, for pouring casting material to said impression. The upper portion positive preferably comprises at least one textured surface to ease adhering of fairing materials thereto.

Optionally, the invention further comprises the steps of photographing the patient's foot, and extrapolating measurements of the foot to facilitate better customization of model portions like the calf or ankle.

The pre-made upper portion may be attached to the lower portion substantially during the casting process of the lower portion.

While the casting process regularly uses plaster, other materials may be used. Meltable materials may optionally be used for the casting and/or for making the upper portion, which allows for coupling the upper and lower portions by heating.

The upper portion may be made of any desirable material such as metal, wood, plastic, plaster, and the like.

### BRIEF DESCRIPTION OF THE DRAWINGS

Different aspects of the invention will be better understood with the aid of the attached drawings, showing preferred embodiments of the invention or depicting stages thereof, in which:

FIG. 1 depicts an example of creating a foot impression in an impression block.

FIG. 2 depicts an example of an upper mold.

FIG. 3 depicts usage of the upper mold and the impression block of FIG. 1.

FIG. 4 depicts the poured moldable material (casting).

FIG. 5 depicts a model after casting, with upper mold removed.

FIG. 6 is another view of a model after casting.

FIG. 7 depicts yet another view of the model after pouring the negative mold with fairing applied, as well as an example of one brace that may be produced in accordance with the invention.

FIG. 8 depicts a pouring stage in another preferred embodiment of the invention.

FIG. 9 depicts a lower portion positive mold of a foot.

FIG. 10 depicts a model lower portion and a model upper portion, prior to joining.

FIG. 11 represents a simplified flow diagram of two preferred embodiments.

### DETAILED DESCRIPTION

FIG. 1 presents the first step (100 in FIG. 11) in the preferred embodiment of the invention. The patient's foot 10 is pressed into an impression block 12 to cause an impression 15. The preferred method utilizes a crush box where the deformable material of the impression block comprises easily deformable foam block, that is being crushed under pressure, preferably by having the patient step onto the impression block, to approximate the shape of the plantar contour of the patient's foot. The impression block may be of uniform or variable thickness and may be made of uniform material or from materials having varying degrees of hardness to provide more accurate measurement, or for other desired physical characteristics if desired. Optionally, the patient's foot is also photographed 105 to provide a vehicle from which measurements can be calculated, and/or measurements of areas such as the width and circumference of the leg can be obtained.

Several options exist for creating a positive foot model after the impression 15 is taken. Two preferred embodiments will be described in detail. It should however be noted that modification to those methods will be clear to the skilled in the art, in light of the explanations provided herein. Thus that the disclosed embodiments and variation thereupon, should not be construed as limiting the invention scope, but rather as examples of utilizing the basic concept of creating an impression of the patient's foot in deformable material, and creating a model of the relevant foot portions utilizing the impression and an upper portion to create a foot and/or leg model.

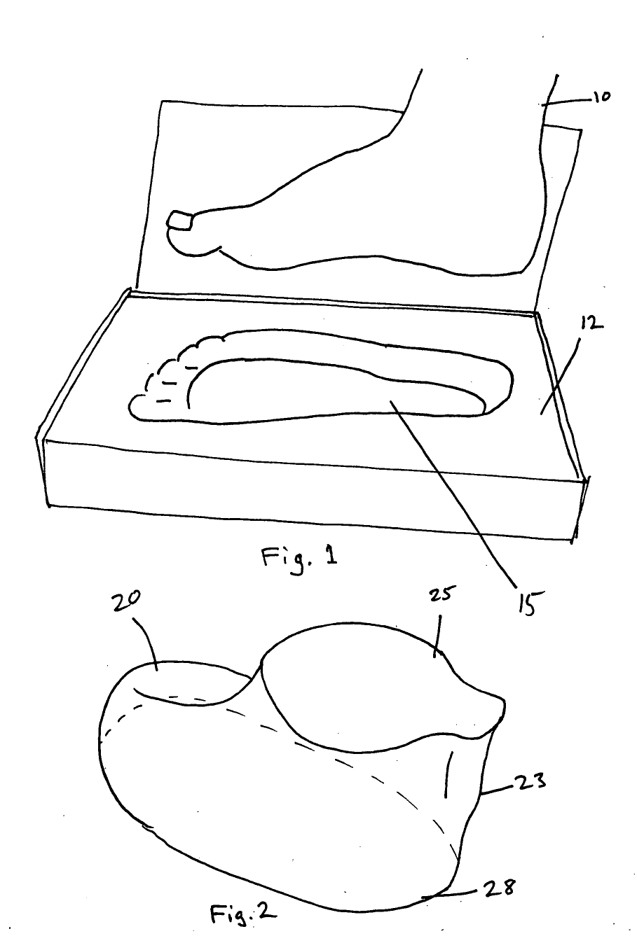

In the first preferred embodiment a pre-made upper portion negative 20 depicted in FIG. 2 is utilized for creating a positive cast of the patient's foot and/or lower leg. Preferably, an upper portion negative is selected to be a bit larger than the leg, and the resulting model is then trimmed by removing material after the casting. The upper portion negative 20 has an inner cavity approximating at least a portion of a person's lower leg or foot, a brace, or any shape allowing construction of a model of a person's leg or brace thereupon. The upper portion negative is preferably hollow, and has an upper opening 25 and a lower opening 28. In other embodiments the upper portion negative may offer alternative placement of openings, as long as there is provided a conduit for allowing the casting material to flow into the impression 15 and to at least a portion of the upper portion. Optionally, the upper portion negative 20 may also have a mandrel 42 attached thereto. The mandrel may be used to ease the handling of the model. Further, the upper portion optionally has a rearward protrusion 23 shaped to allow making a specific and desirable AFO such as a DorsiBrace™.

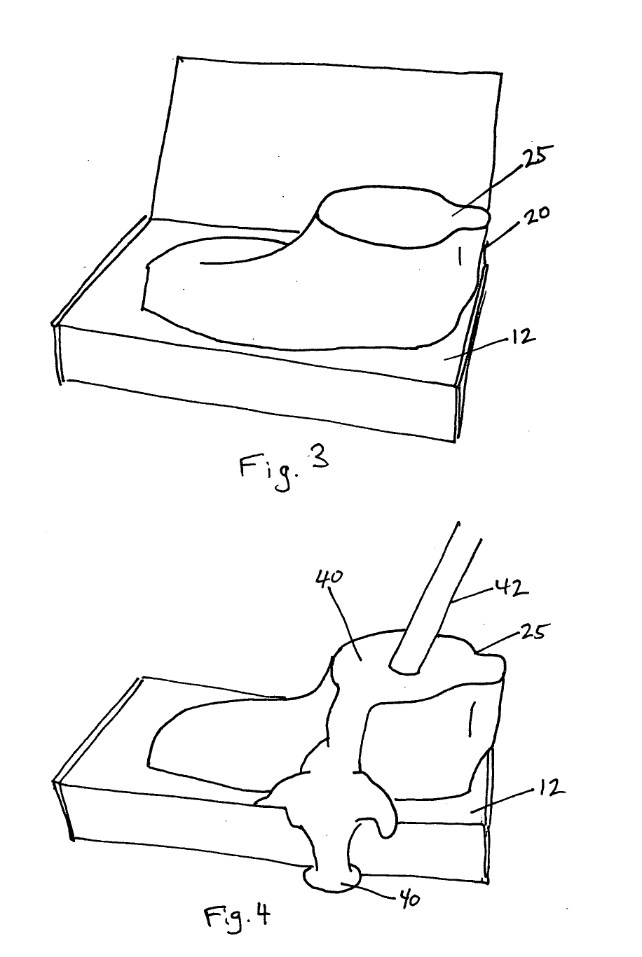

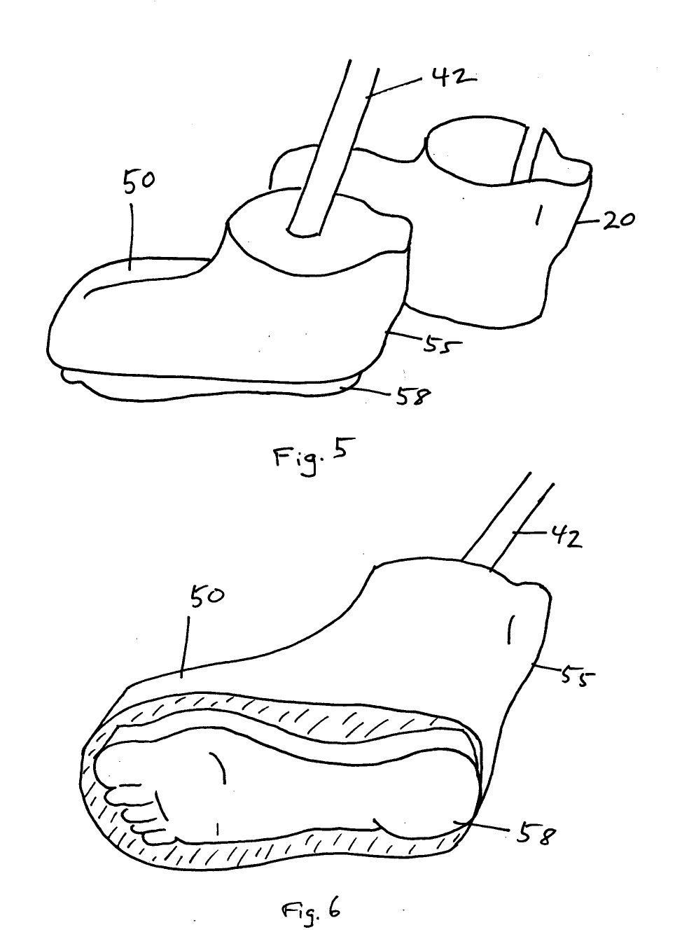

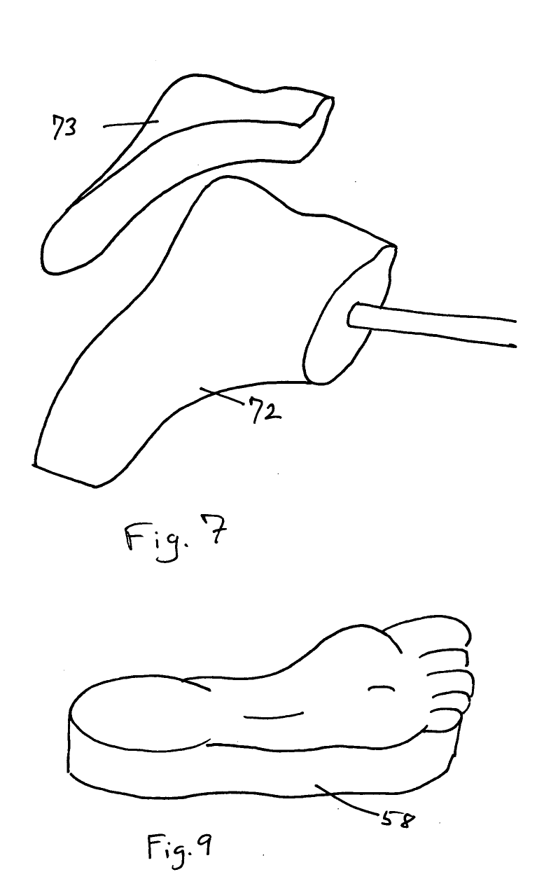

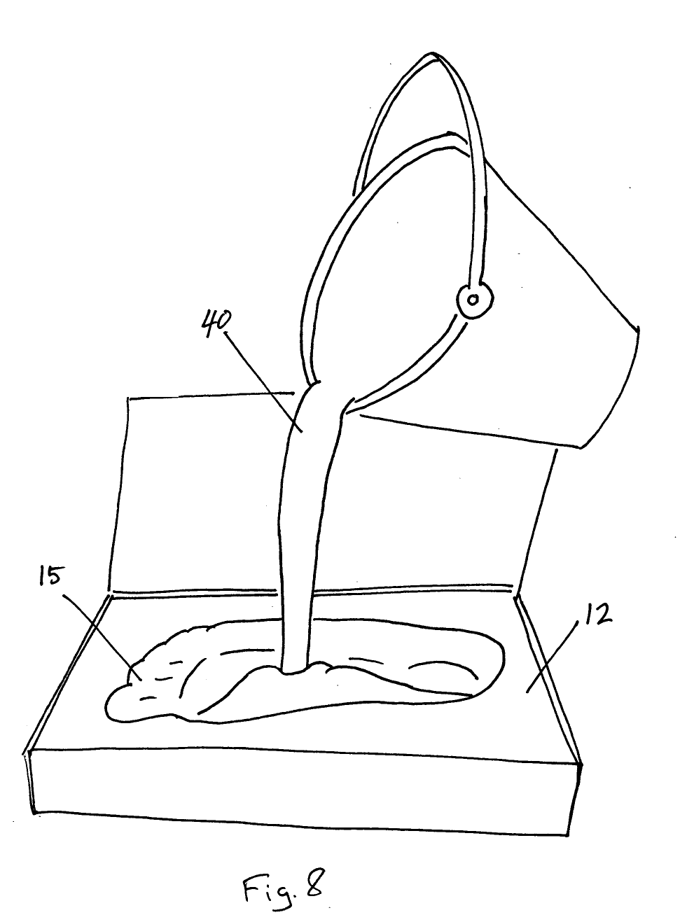

In the preferred embodiment, as seen in FIG. 3, the upper portion negative 20 is placed 110 in an approximate alignment with impression 15 previously made in the impression block 12. FIG. 4 depicts step 120 of casting the leg model. Any casting material 40 may be utilized, but the preferred embodiment utilizes plaster. The plaster is poured into the upper opening 25 of the upper portion and flows to fill the impression 15 and at least a portion of the upper portion negative 20. If desired, a mandrel 42 may be inserted 125 into the casting material to assist mounting the model. The mandrel may be added before, during or shortly after the casting step 120.

FIGS. 5 and 6 depict two views of the cast model. In FIG. 5 the upper portion negative 20 is shown removed. The model 50 is shown, comprising the lower portion 58 formed by the impression block, and the upper portion positive 55 connected thereto. A fairing process 130 may comprise adding material 72 or removing material 72 and in general is directed to shape the model to facilitate creating a brace that will better fit the given patient leg. Fairing may be made of any desired material such as plaster, plastics, ceramics, putty, and other materials that are conveniently shaped.

Once the model is complete, numerous methods are known to the skilled in the art for making of the AFO. Commonly, a thermoformable plastic sheet (e.g. polyethylene, polypropylene, and the like) is draped over the model, and vacuum is applied, to form the brace. An AFO 73 is but one type of such brace that may be created by such process.

A second preferred embodiment of the process for making the foot model after the impression 15 was made in the impression block 12 is depicted in FIGS. 8-10. In this embodiment, casting material 40 is poured into the impression 15 to cast 150 the lower portion 58 of the foot model, as depicted in FIG. 8. The cast lower portion is depicted in FIG. 9.

After the lower portion 58 is cast, it is coupled to a prefabricated upper portion positive 85. The upper portion positive is selected to generally fit the patients' leg size, and preferably to be a bit smaller, so fairing material can be easily added for better shaping. The prefabricated upper portion may be made of any convenient material such as wood, plastic, metal, ceramic, rubber, plaster, and the like. Preferably, a plaster upper portion positive is used, to provide low heat conduction which is desirable if more uniform setting of a thermoformable plastic AFO is required. Also Preferably the upper portion positive has a mandrel attached thereto. Optionally, a plurality of holes (not shown) or a surface texturing exist in the upper portion positive, to provide better hold for fairing material. The upper portion positive preferably has a flat coupling area for coupling to the lower portion 58, but it may also have protrusions or cavities to ease coupling to the lower portion (Not shown).

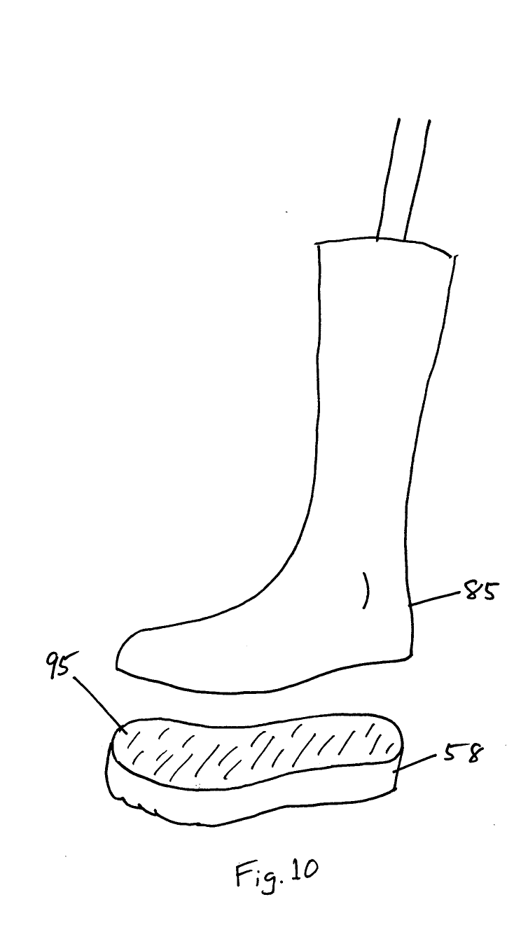

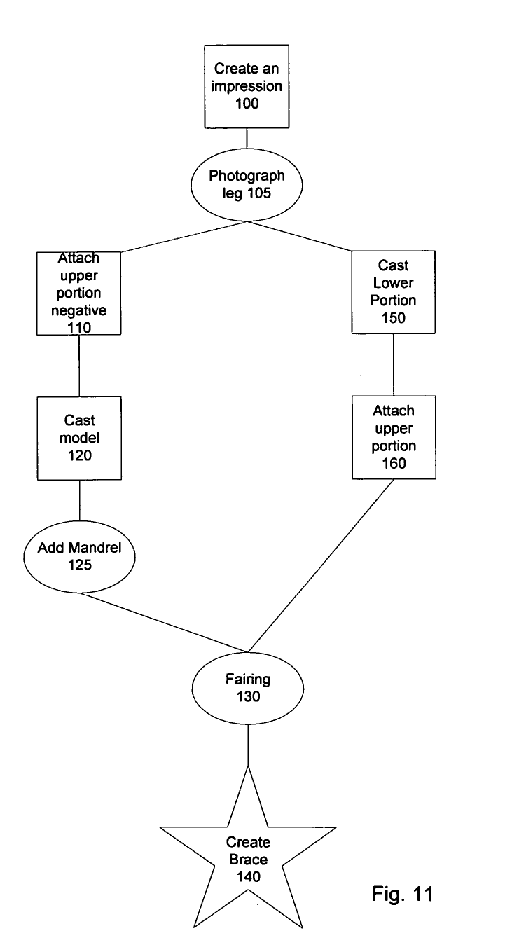

FIG. 10 depicts the preferred method of attaching 160 the prefabricated upper portion positive 85 to the cast lower portion 58 by using glue 95 or similar adhesive material that may be applied to the upper portion, the lower portion, or to both.

Many alternative methods exist for coupling the lower portion 58 and the upper portion 85. By way of non-limiting example, fasteners, plaster, glue and/or adhesive, protrusions in either portion or in both, plug and socket arrangements, different welding methods, attachment via an external object such as draping a net or cloth over both parts, ropes, and the like. Yet another example of coupling is by interference, i.e. by having one or more parts of one portion extend into and ‘interfere’ with the other portion. In general, any method of attaching two objects together, either directly or with an intermediate layer therebetween, may be utilized to couple the upper and lower portions. Coupling may also be carried out during the casting of the lower foot, such as by inserting portions of the upper portion positive into the lower portion while it cures, and/or by having some of the casting material of the lower portion extend into cavities or holes within the upper portion positive, or by using casting material that can stick to the upper portion positive. Many variations exist on such a method of mutual coupling and they should be considered equivalent for the purpose of attachment of the upper and lower portions. An intermediate layer may also be used to provide coupling and/or to ease fairing.

As shown in FIG. 11, fairing the model 130 is an optional step, but is desired in most cases. As was described before, the preferred embodiment utilizes the closest smallest prefabricated upper portion, and the fairing is used to bring the model to size by adding or removing material as needed.

A variation of this embodiment is to combine a part of the first described preferred embodiment, by utilizing the upper portion negative to create an upper portion positive, or a portion thereof. In such process the upper portion positive may be completely cast, and then attached to the lower portion in the impression block or after the lower portion casting had been completed. Alternatively, the upper portion positive may be coupled to the lower portion during the casting process when the casting material is not completely cured.

Once the foot model is created, the process of making an AFO is well known, as described.

Those skilled in the art will clearly recognize that the steps and other details provided above are but examples of how to make and/or use the various aspects of the invention, and that one skilled in the art would, in light of these specifications, be able to provide numerous obvious changes to these examples, such as order of steps, additional steps, utilizing different materials, attachment methods, or different casting processes, and that such changes fall within the scope of the invention. While there has been provided a complete description of what is at present believed to be the best methods to practice the invention, the invention is clearly directed at covering such modifications and equivalents as will be clear to those skilled persons, and not limited to the order, steps, materials, or other aspects of the description and drawings provided by way of non-limiting example only.

1. A process for making at least a partial model of a leg, the process comprising the steps of:
forming a three dimensional impression of a plantar surface of a foot in a deformable impression block;
coupling an upper portion negative mold with said impression;
casting a leg model utilizing said impression and upper mold negative.

2. A process for making at least a partial model of a leg as claimed in claim 1, further comprising the step of coupling a mandrel to said casting.

3. A process for making at least a partial model of a leg as claimed in claim 2, wherein said step of coupling is carried out during the casting process or in temporal proximity thereto.

4. A process for making at least a partial model of a leg as claimed in claim 1, further comprising the step of fairing said casting.

5. A process for making at least a partial model of a leg as claimed in claim 1, wherein said impression block comprise deformable foam.

6. A process for making at least a partial model of a leg as claimed in claim 1, wherein said upper portion comprises a cavity approximately conformant to a person's upper foot portion.

7. A process for making at least a partial model of a leg as claimed in claim 1, wherein said step of forming is carried out by having a patient's foot deform at least a portion of the impression block to create a negative impression

8. A process for making at least a partial model of a leg as claimed in claim 1, further comprising the step of photographing said patients' leg or a portion thereof.

9. A process for making at least a partial model of a leg as claimed in claim 1, further comprising the step of providing measurements of the patients' leg or portions thereof.

10. A process for making at least a partial model of a leg as claimed in claim 1, wherein said upper portion comprises a rearward protrusion.

11. A process for making at least a partial model of a leg, the process comprising the steps of:
forming a three dimensional impression of a plantar surface of a foot in a deformable impression block;
casting a lower portion positive utilizing said impression;
coupling a prefabricated upper portion positive to said lower portion positive to provide at least a partial leg model.

12. A process for making at least a partial model of a leg as claimed in claim 11, further comprising the step of fairing the coupled upper and lower portion.

13. A process for making at least a partial model of a leg as claimed in claim 11, wherein said step of coupling is performed by gluing said upper and lower portions, or by adhering said upper and lower portions, or by a combination thereof.

14. A process for making at least a partial model of a leg as claimed in claim 11, wherein said step of coupling is performed utilizing a coupling method selected from a list consisting of screwing, fastening, coupling using a plug and socket arrangement, mutual coupling, interference coupling, intermediate layer coupling, or a combination thereof.

15. A process for making at least a partial model of a leg as claimed in claim 11, wherein said step of coupling is performed by attaching said upper portion to lower portion while said lower portion is being set.

16. A process for making at least a partial model of a leg as claimed in claim 15, wherein said upper portion further has at least one cavity, to allow casting material to flow into said cavity.

17. A process for making at least a partial model of a leg as claimed in claim 11, wherein said upper portion has a conduit therein, for pouring casting material to said impression.

18. A process for making at least a partial model of a leg as claimed in claim 11, wherein said step of coupling is performed utilizing a coupling method selected from a list consisting of tying said upper and lower portions together, draping material over said upper and lower portions or a portion thereof, or a combination thereof.

19. A process for making at least a partial model of a leg as claimed in claim 11, wherein said upper portion positive is made at least partially of material selected from the list consisting of wood, metal, plastic, plaster, ceramic, composite, rubber, or a combination thereof.

20. A process for making at least a partial model of a leg as claimed in claim 11, wherein said upper portion positive comprises a mandrel.

21. A process for making at least a partial model of a leg as claimed in claim 11, wherein said upper portion positive comprises a plurality of cavities formed therein in proximity to its lower end, for providing improved hold to fairing material.

22. A process for making at least a partial model of a leg as claimed in claim 11, wherein said upper portion positive comprises at least one textured surface.

23. A process for making at least a partial model of a leg as claimed in claim 11, wherein said upper portion positive comprises a substantially flat surface for coupling said lower portion.

24. A process for making at least a partial model of a leg as claimed in claim 11, further comprising the step of utilizing an intermediate layer for coupling between said upper and lower portions.

25. A process for making at least a partial model of a leg as claimed in claim 11, further comprising the step of casting said upper portion in an upper portion negative mold.

26. A process for making at least a partial model of a leg as claimed in claim 25, wherein said step of casting of said upper portion comprises only a partial casting.

27. A process for making at least a partial model of a leg, the process comprising the steps of:
creating a three dimensional impression of a patients' plantar surface in deformable foam;
providing an upper portion negative mold having a cavity therein, said cavity having an upper opening and a lower opening;
aligning said lower opening with said impression;
pouring casting material into said upper opening so as to fill said impression and at least a portion of said upper portion, to form a model.

28. A process for making at least a partial model of a leg as claimed in claim 27, further comprising the step of fairing said model.

29. A process for making at least a partial model of a leg as claimed in claim 27, wherein said upper portion negative mold is selected to be larger than the correspondingly modeled portion of the patient's leg.

30. A process for making at least a partial model of a leg as claimed in claim 27, further comprising the step of coupling a mandrel to said model.

31. A process for making at least a partial model of a leg as claimed in claim 27, wherein said upper portion negative mold is selected to be smaller than the correspondingly modeled portion of the patient's leg.
